(19) United States
(12) Patent Application Publication
(10) Pub. No.: US 2022/0196351 A1
(43) Pub. Date: Jun. 23, 2022

(54) RADIATIVE COOLING DEVICE BASED ON INCIDENCE AND EMISSION ANGLE CONTROL

(71) Applicant: KOREA ADVANCED INSTITUTE OF SCIENCE AND TECHNOLOGY, Daejeon (KR)

(72) Inventors: Jonghwa SHIN, Daejeon (KR); Kyungsun YUN, Daejeon (KR); Suwan JEON, Daejeon (KR)

(21) Appl. No.: 17/560,394

(22) Filed: Dec. 23, 2021

(30) Foreign Application Priority Data
Dec. 23, 2020 (KR) 10-2020-0182599

(51) Int. Cl. F28F 27/00; F28F 13/18

(52) U.S. Cl. CPC F28F 27/00; F28F 2245/06; F28F 13/18

(57) ABSTRACT

The present disclosure relates to a radiative cooling device based on incidence and emission angle control using an angle controller, and a method of cooling an object using the radiative cooling device.

### CROSS-REFERENCE TO RELATED APPLICATION

This application claims the benefit under 35 USC 119(a) of Korean Patent Applications No. 10-2020-0182599 filed on Dec. 23, 2020 in the Korean Intellectual Property Office, the entire disclosures of which are incorporated herein by reference for all purposes.

### TECHNICAL FIELD

The present disclosure relates to a radiative cooling device based on incidence and emission angle control using an angle controller, and a method of cooling an object using the radiative cooling device.

### BACKGROUND

A radiative cooling device refers to a device capable of being cooled lower than the ambient temperature by itself without external energy even under sunlight. In the current situation where the energy demand has increased worldwide due to global warming, the radiative cooling device which is helpful for cooling and keeping the temperature of a building or an object without energy consumption may greatly affect the global energy industry.

A conventional device is designed for 100% absorption (or emission) in the range of wavelength of 8 μm to 13 μm to implement cooling to temperature lower than the atmospheric temperature. In this case, the radiative cooling device is designed such that the same operation works in all directions including a direction perpendicular to the planar radiative cooling device. However, this design cannot effectively release radiative heat for the following three reasons, and, thus, the temperature of the device cannot be lowered sufficiently: (1) Since the thickness of the atmosphere is large in a direction with a high zenith angle, the scattering and absorption of light becomes strong. Thus, the atmosphere absorbs and releases radiative heat very strongly even in the range of wavelength of from 8 μm to 13 μm. Therefore, the conventional design to improve the absorptance in all directions causes an increase in the absorption of radiative heat from a high zenith angle region and thus causes a decrease in the cooling performance of the device. (2) To maximize the effective cooling power, radiative heat needs to be released to a low zenith angle region in the range of wavelength of from 8 μm to 13 μm in which the atmosphere is transparent. In this case, if a conventional method of controlling the absorptance and emissivity simply depending on the angle range (the emissivity is 0% from the high zenith angle region and 100% from the low zenith angle region) is applied, the amount of released radiative energy is decreased, which causes a decrease in the cooling rate and makes it difficult to perform cooling to a sufficiently low temperature. (3) The radiative cooling device exchanges radiative heat with the surrounding environment (buildings, cars, trees, etc.) in a direction with a high zenith angle. Therefore, the conventional radiative cooling device greatly changes in the radiative cooling performance depending on the surrounding environment, and cannot implement stable cooling performance. In some conventional techniques, a planar mirror is placed in a high zenith angle region to block absorption of radiative heat by the surrounding environment (buildings, forest, ground, etc.). However, in this case, control of the angle of the radiative heat is not considered, and, thus, the mirror serves only as a simple barrier. Therefore, it is impossible to implement efficient cooling.

Accordingly, in order to block the influence of the surrounding environment and the sun, control of absorbed and released radiative heat by placing a shield around a device has been studied. However, the amount of released radiative heat is decreased by the shield, and, thus, the cooling performance is degraded (Zhou, L., Song, H., Liang, J. et al. A polydimethylsiloxane-coated metal structure for all-day radiative cooling. Nat Sustain 2, 718-724 (2019)). Therefore, in the present technical field, there has been a demand for a radiative cooling device having a new structure capable of stably performing cooling to a temperature below zero even in the middle of the day in midsummer without consumption of electric and chemical energy.

### SUMMARY

The present disclosure relates to a radiative cooling device based on incidence and emission angle control using an angle controller to control incident radiative heat depending on the angle and thus minimize absorption of radiative heat and secure the maximum amount of radiative heat emitted from a thermal emitter.

However, the problems to be solved by the present disclosure are not limited to the above-described problems. Although not described herein, other problems to be solved by the present disclosure can be clearly understood by a person with ordinary skill in the art from the following descriptions.

A first aspect of the present disclosure provides a radiative cooling device including an angle controller and a thermal emitter. The angle controller allows radiative heat incident from the outside to be absorbed by the thermal emitter selectively depending on an incidence angle and allows radiative heat emitted from the thermal emitter to be emitted regardless of an emission angle.

A second aspect of the present disclosure provides a method of cooling an object using the radiative cooling device according to the first aspect.

According to an embodiment of the present disclosure, the angle controller of the radiative cooling device allows radiative heat incident from the surrounding environment (sun, atmosphere, etc.) to be absorbed by the thermal emitter selectively depending on an incidence angle and simultaneously allows radiative heat emitted from the thermal emitter to be emitted to the surrounding environment regardless of an emission angle. Therefore, the radiative cooling device according to an embodiment of the present disclosure can achieve a higher cooling rate and a lower cooling temperature than a conventional radiative cooling device.

According to embodiments of the present disclosure, the radiative cooling device can perform semipermanent cooling performance without using energy. Therefore, it can substitute for most of conventional cooling and air conditioning systems that perform cooling by consuming energy for heat conduction and circulation. In particular, the radiative cooling device can implement a radiative cooling system in an easy and inexpensive way by adding subsidiary materials, such as a simple plate type structure, aluminum foil and styrofoam, to a mid-infrared thermal emitter. Therefore, it can be used as a no-power freezer or a no-power air conditioning system in developing countries.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a schematic diagram showing the function and principle of a radiative cooling device according to an embodiment of the present disclosure.

FIG. 2A is a schematic diagram illustrating a radiative cooling device that uses a three-dimensional hemispherical parabolic mirror as an angle controller according to an embodiment of the present disclosure.

FIG. 2B is a schematic diagram illustrating a radiative cooling device that uses a two-dimensional semicylindrical parabolic mirror as an angle controller according to an embodiment of the present disclosure.

FIG. 3A is a schematic diagram illustrating a radiative cooling device that uses a reflective metalens as an angle controller according to an embodiment of the present disclosure.

FIG. 3B is a schematic diagram illustrating a radiative cooling device that uses a transmissive metalens as an angle controller according to an embodiment of the present disclosure.

FIG. 4 is a schematic diagram illustrating a portable using a radiative cooling device according to an embodiment of the present disclosure.

FIG. 5A shows incidence and emission profiles of radiative heat absorbed by a thermal emitter when a cone-shaped reflective mirror is used according to a comparative example of the present disclosure.

FIG. 5B shows incidence and emission profiles of radiative heat absorbed by a thermal emitter when an angle controller in the form of a parabolic mirror is used according to an example of the present disclosure.

FIG. 5C is a graph sorting the number of radiative rays absorbed by a thermal emitter depending on the zenith angle at a constant r/H value based on FIG. 5A and FIG. 5B according to an example of the present disclosure.

### DETAILED DESCRIPTION

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the another element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination(s) of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through the whole document, a phrase in the form “A and/or B” means “A or B, or A and B”.

Through the whole document, the term “sunlight” refers to the electromagnetic radiation of the sun including ultraviolet light, visible light and near infrared light (in a wavelength range of 0.3 μm to 4 μm).

Through the whole document, the term “mid-IR (MIR)” refers to the electromagnetic radiation with a wavelength of from 8 μm to 13 μm that cannot be absorbed by the atmosphere among infrared light which is black-body radiation from an object.

Through the whole document, the term “zenith angle” refers to the angle between a normal line to the ground surface and radiative heat rays, and low zenith angles span a narrow range of less than 45° in the vertical and horizontal directions with respect to the normal line and high zenith angles span a range other than the low zenith angles.

Hereinafter, embodiments and examples of the present disclosure will be described in detail with reference to the accompanying drawings. However, the present disclosure may not be limited to the following embodiments, examples, and drawings.

A first aspect of the present disclosure provides a radiative cooling device including an angle controller and a thermal emitter. The angle controller allows radiative heat incident from the outside to be absorbed by the thermal emitter selectively depending on an incidence angle and allows radiative heat emitted from the thermal emitter to be emitted regardless of an emission angle. The angle controller of the radiative cooling device allows radiative heat incident from the surrounding environment (sun, atmosphere, etc.) to be absorbed by the thermal emitter selectively depending on an incidence angle and simultaneously allows radiative heat emitted from the thermal emitter to be emitted to the surrounding environment regardless of an emission angle. Therefore, the radiative cooling device can achieve a higher cooling rate and a lower cooling temperature than a conventional radiative cooling device.

In an embodiment of the present disclosure, the angle controller may allow incident radiative heat to be at least one of transmitted, reflected and absorbed selectively depending on an incidence angle and allow radiative heat emitted from the thermal emitter to be transmitted or reflected to the outside regardless of an emission angle.

In an embodiment of the present disclosure, the angle controller may allow radiative heat incident at a low zenith angle to be transmitted or reflected to the thermal emitter and allow radiative heat incident at a high zenith angle to be absorbed or to be reflected or transmitted to a direction in which the thermal emitter is not located.

In an embodiment of the present disclosure, the angle controller may allow radiative heat emitted from the thermal emitter to be transmitted or reflected at a low zenith angle.

Specifically, as the zenith angle increases, the atmospheric layer increases in thickness and the amount of the radiative heat from the atmospheric layer increases. Therefore, the absorption of radiative heat incident at a high zenith angle needs to be blocked to improve the cooling performance. However, if the absorptance is regulated simply depending on the angle without an angle controller, the total amount of radiative heat emitted from the thermal emitter naturally decreases. Therefore, in this case, the cooling performance is degraded compared to a case where the absorptance is high in all directions. Also, high surroundings, such as buildings or mountains, serve as a radiative heat source with a high zenith angle. Therefore, the absorption (emission) depending on the angle needs to be controlled to secure stable cooling performance regardless of the surrounding environment. The radiative cooling device according to the present disclosure uses the angle controller and thus can function to minimize radiative heat absorbed by the radiative cooling device from the surrounding environment, such as the sun, the atmosphere, etc., (at a high zenith angle), allow only radiative heat incident at a low zenith angle to be absorbed by the thermal emitter selectively by using the angle controller and maximize the effective cooling power by maintaining the amount of radiative heat released from the thermal emitter to the surrounding environment. Therefore, the radiative cooling device according to the present disclosure can achieve stable cooling performance regardless of the surrounding environment.

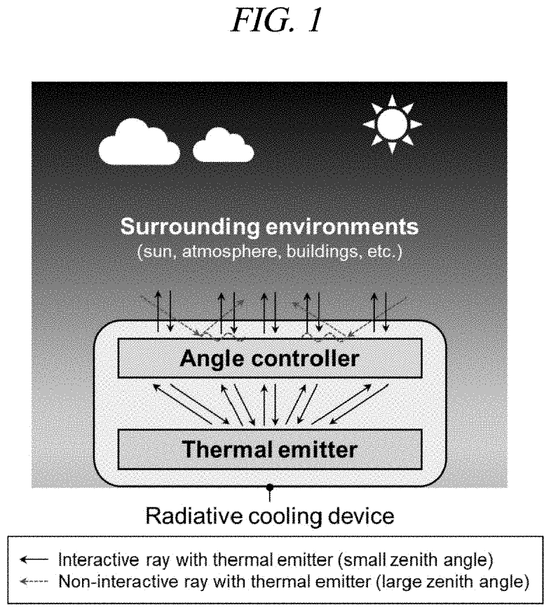

In an embodiment of the present disclosure, the angle controller may control radiative heat depending on the zenith angle. Referring to FIG. 1, the angle controller may (1) allow radiative heat from the surrounding environmental elements (atmosphere, buildings, etc.) to be reflected or absorbed to block the inflow of the radiative heat in a high zenith angle region (red region) and allow radiative heat released from the thermal emitter to be maintained (blue region). Also, the angle controller may (2) allow radiative heat of the radiative cooling device to be exchanged with the surrounding environment to release the radiative heat from the radiative cooling device in a low zenith angle region (blue region). Here, it is important to allow radiative heat emitted from radiative cooling device to be released in all directions and allow only radiative heat in a low zenith angle region to be absorbed. Meanwhile, the angle controller may also be applied to radiative heat in the sunlight region (UV, visible and near-infrared) as well as in the mid-IR region. Therefore, since the radiative cooling device according to the present disclosure has the maximized effective cooling power (radiative power to be effectively released), it can achieve a higher cooling rate and release a large amount of radiative heat even at a low temperature and thus can perform cooling to a lower temperature than a conventional one.

In an embodiment of the present disclosure, the angle controller may function to allow radiative heat incident from a low zenith angle region to converge on specific area (points, or focus), and the thermal emitter may be located at the specific area, points, or focus.

In an embodiment of the present disclosure, the angle controller may allow 50% or more, 75% or more or 90% or more of radiative heat incident to the radiative cooling device at a zenith angle of from 0° to 90° to be absorbed by the thermal emitter at an angle of 20° or less, 35° or less, or 45° or less, respectively.

In an embodiment of the present disclosure, if a solid angle region for radiative heat released from the thermal emitter before reflection or transmission to the angle controller is A and a solid angle region for the radiative heat released from the thermal emitter after the reflection or transmission is B, the angle controller may reduce a solid angle region for radiative heat released to the outside at a solid angle ratio of B/A<1.

In an embodiment of the present disclosure, the angle controller may be located between the zenith and the thermal emitter, between the thermal emitter the ground surface or at both locations.

In an embodiment of the present disclosure, the thermal emitter may be located at the focus of the angle controller. Specifically, the thermal emitter may be located at the focus of the angle controller and may absorb radiative heat incident from the outside selectively by the angle controller. When the angle controller is located between the zenith and the thermal emitter, radiative heat incident at a low zenith angle may pass through the angle controller and then may be absorbed by the thermal emitter located at the focus of the angle controller and radiative heat incident at a high zenith angle may be absorbed or reflected by the angle controller and thus may not be absorbed by the thermal emitter. When the angle controller is located between the thermal emitter and the ground surface, radiative heat incident at a low zenith angle may be reflected by the angle controller and then may be absorbed by the thermal emitter located at the focus of the angle controller and radiative heat incident at a high zenith angle may be absorbed or reflected by the angle controller or transmitted toward a direction other than the focus and thus may not be absorbed by the thermal emitter. Therefore, the thermal emitter located at the focus may selectively absorb controlled radiative heat. Meanwhile, when the angle controller is located between the zenith and the thermal emitter, even if radiative heat emitted from the thermal emitter proceeds toward the angle controller, the angle controller may transmit the radiative heat at a low zenith angle. Also, when the angle controller is located between the thermal emitter and the ground surface, radiative heat emitted from the thermal emitter proceeds toward the angle controller, the angle controller may reflect the radiative heat at a low zenith angle. Therefore, the thermal emitter may be located at the focus and all the radiative heat emitted from the thermal emitter may be released to the outside. That is, if the angle controller is in the form of a planar lens or mirror with no focus, a radiative cooling device based on incidence and emission angle control cannot be implemented.

In an embodiment of the present disclosure, the angle controller may include at least one selected from a convex lens, a concave lens, a Fresnel lens, a metasurface, a metamirror and a metalens. Specifically, the angle controller may control the angle by means of reflection through a mirror, diffraction through a lattice and a regular pattern structure, or the like. To do so, a convex lens, a parabolic mirror including a concave mirror, a Fresnel lens, a metasurface, a metamirror or a metalens may be used as the angle controller.

In an embodiment of the present disclosure, if the angle controller is the parabolic mirror, the angle controller may be located between the thermal emitter and the ground surface. Specifically, radiative heat emitted downwards from the thermal emitter may be reflected by the angle controller and released in a direction perpendicular to the ground surface (at a low zenith angle), and radiative heat incident to radiative cooling device from the outside may be transferred to the thermal emitter only when it is incident to the angle controller at a low zenith angle.

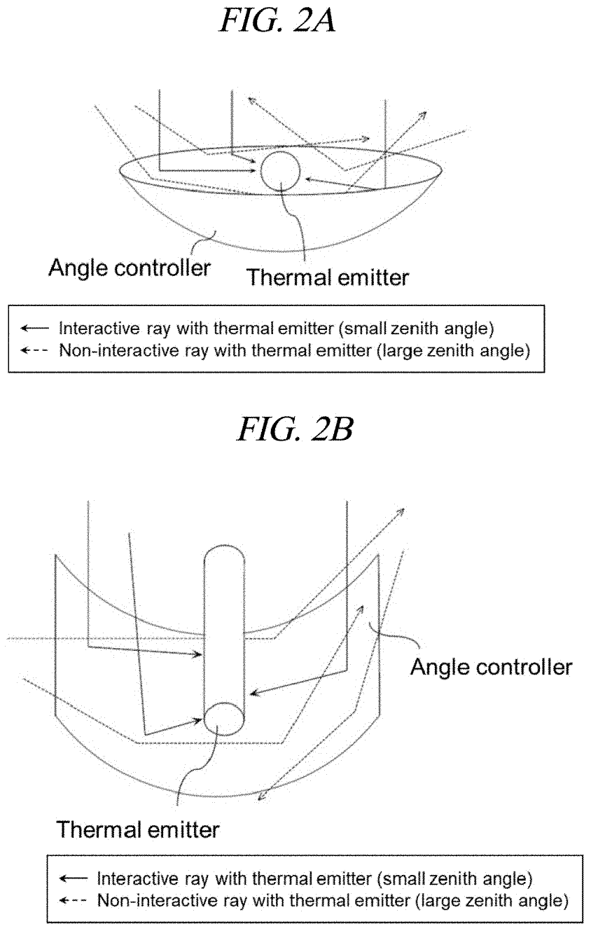

In an embodiment of the present disclosure, the angle controller may be the parabolic mirror which may have a three-dimensional paraboloid shape or a two-dimensional paraboloid shape depending on the type of use. Referring to FIG. 2A and FIG. 2B, if the parabolic mirror has the three-dimensional paraboloid shape, the radiative cooling device may be used as a portable drug refrigerator or an ice cream carrier (FIG. 2A), and if the parabolic mirror has the two-dimensional paraboloid shape, the radiative cooling device may be used as a water pipe or for cooling electric wire (FIG. 2B). The parabolic mirror may be made of a metallic material (Ag, Al or the like.) or a highly conductive material (ITO or the like). As a result of calculation, it was found that when a parabolic mirror and a thermal emitter operating in a wavelength range of 8 μm to 13 μm under normal temperature and normal pressure are used for a radiative cooling device, the radiative cooling device can perform cooling by 20° C. In this case, the radiative cooling device can perform cooling to a lower temperature by about 8° C. at a higher cooling rate than a two-dimensional planar radiative cooling device.

In an embodiment of the present disclosure, the angle controller may include both the convex lens and the concave mirror. In this case, the convex lens may be located between the zenith and the thermal emitter, and the concave mirror may be located between the thermal emitter and the ground surface.

In an embodiment of the present disclosure, the angle controller may be a reflective metamirror or a transmissive metalens.

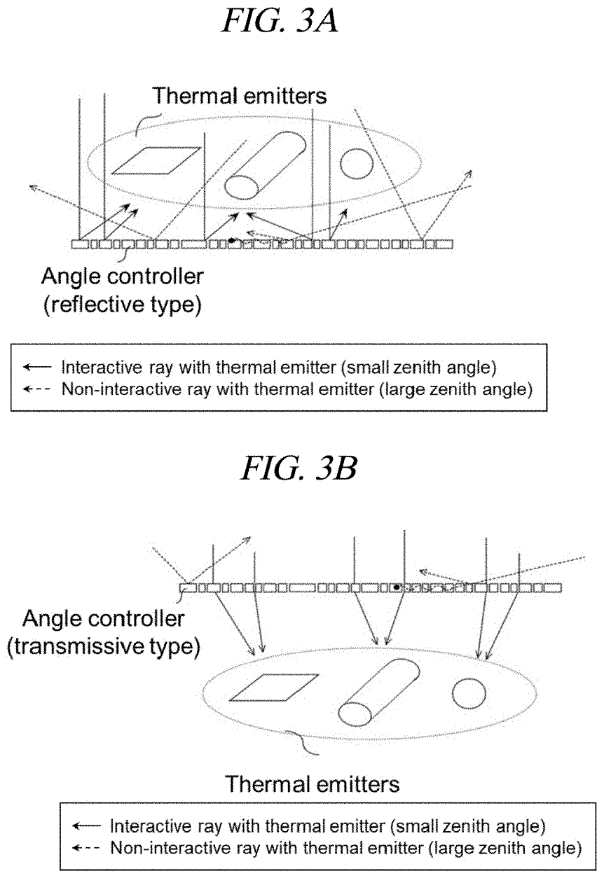

In an embodiment of the present disclosure, if the angle controller is the reflective metamirror, the angle controller may be located between the thermal emitter and the ground surface. Referring to FIG. 3A, if the angle controller is a reflective metamirror in the mid-IR region, it may operate like the parabolic mirror so as to cause the thermal emitter located at the focus to exchange radiative heat with the outside only in a low zenith angle region. In the sunlight region, the reflective metamirror may absorb the sunlight or cause the sunlight to be out of focus so as to block absorption of the sunlight by the thermal emitter. The reflective metamirror may have a regular pattern or a lattice structure, and a phase on the surface of the reflective metamirror may be appropriately regulated depending on the wavelength to maximize reflection in the mid-IR region. Also, the reflective metamirror may include a metal (Ag, Al or the like), a semiconductor (Si, Ge or the like) or a dielectric material (SiO₂, TiO₂ or the like).

In an embodiment of the present disclosure, if the angle controller is the transmissive metalens, the angle controller may be located between the zenith and the thermal emitter. Referring to FIG. 3B, the transmissive metalens may serve as a lens in the mid-IR region to concentrate mid-IR rays incident at a low zenith angle from the outside to the thermal emitter located at the focus. Here, the transmissive metalens is designed to have multi focus points unlike a typical refractive index-based lens, and, thus, even if the thermal emitter under the transmissive metalens has a large area, radiative heat may be effectively released. Also, even if radiative heat incident at a high zenith angle is absorbed, reflected or transmitted by the transmissive metalens, the radiative heat may proceed toward a location other than the focus where the thermal emitter is located and thus may not reach thermal emitter under the transmissive metalens. Further, the angle controller may include both the reflective metamirror and the transmissive metalens. In this case, the transmissive metalens may be located between the zenith and the thermal emitter, and the reflective metamirror may be located between the thermal emitter and the ground surface.

In an embodiment of the present disclosure, the thermal emitter may include a multilayered thin film, a polymer layer including a regular pattern structure, a polymer layer including dispersed nanoparticles, a metamaterial or a metasurface. Specifically, the thermal emitter may function to release radiative heat from the radiative cooling device, and may include a thermal emitter operating in a wavelength range of 8 μm to 13 μm or a thermal emitter operating in the whole mid-IR region. The nanoparticles may include nanoparticles, microparticles or core-shell structure particles. If the thermal emitter performs an angle control function by reflecting mid-IR rays (radiative heat), the thermal emitter may be a conductive material including a metal or ITO, and if the thermal emitter performs an angle control function by transmitting mid-IR rays (radiative heat), the thermal emitter may be a polymer material, a dielectric material or a doped semiconductor. Specifically, the dielectric material may include at least one selected from ZnS, ZnSe, BaF₂, CaF₂, MgF₂, NaCl, KBr, KCl, Ge, GaAs, Si and CdTe.

In an embodiment of the present disclosure, the polymer in the thermal emitter may be at least one selected from the group consisting of poly(dimethylsiloxane) (PDMS), polyethylene (PE), polystyrene (PS) and polypropylene (PP), but is not limited thereto.

In an embodiment of the present disclosure, the angle controller may increase in area as the thermal emitter increases in area.

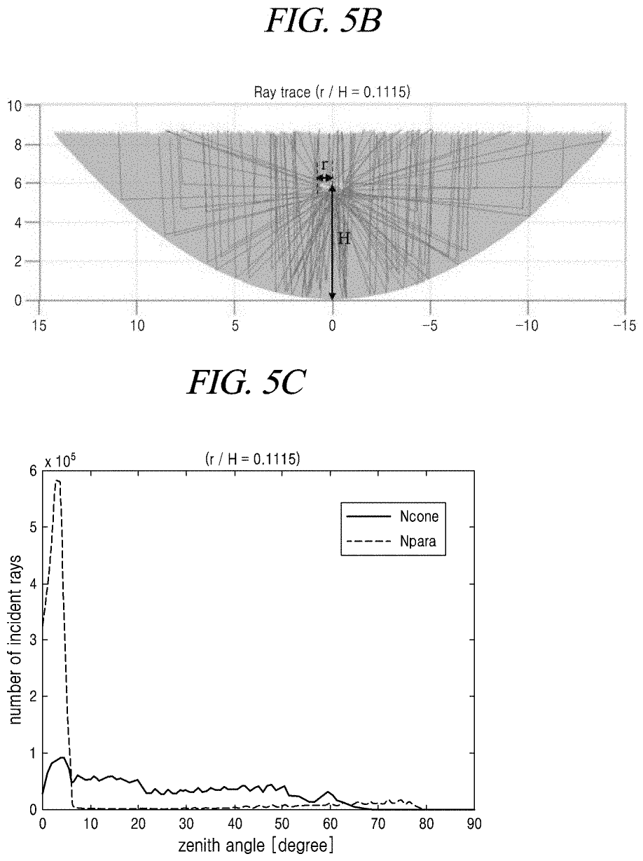

FIG. 5A to FIG. 5C confirm the importance of the shape of the angle controller, the presence of a focus of the angle controller, and the location of the thermal emitter at the focus. FIG. 5A shows incidence and emission profiles of radiative heat absorbed by a thermal emitter when a cone-shaped reflective mirror having a spherical lower part and left and right planar sides is used according to a comparative example of the present disclosure. FIG. 5B shows incidence and emission profiles of radiative heat absorbed by a thermal emitter when an angle controller in the form of a parabolic mirror is used according to an example of the present disclosure. The thermal emitter has a lower hemispherical shape. Red lines are routes of incident and emitted radiative heat and show the results of simulation at various solid angles of radiative heat emitted from the surface of the thermal emitter. When simulations of routes of radiative heat from the thermal emitter at various solid angles were performed, the percentage of radiative heat absorbed at a low zenith angle to radiative heat absorbed by the thermal emitter is associated with a radius R of the thermal emitter and a distance (height) H between the thermal emitter and the angle controller. As the r/H ratio decreases, the percentage of radiative heat absorbed at a low zenith angle increases. Even when r increases, if the r/H ratio is maintained at a constant level by increasing H, the percentage of radiative heat absorbed at a low zenith angle can be constant.

First, referring to the results of simulation shown in FIG. 5A and FIG. 5B, it can be seen from the distribution of red lines that when the cone-shaped reflective mirror is used, radiative heat incident from a low zenith angle region and radiative heat incident from a high zenith angle region are absorbed by the thermal emitter with a uniform distribution. It can be seen that when the parabolic mirror angle controller is used, zenith angle radiative heat incident from a low zenith angle region and some of radiative heat incident from a high zenith angle region are absorbed by the thermal emitter, but some of radiative heat incident from a high zenith angle region is absorbed without passing through the angle controller and all of radiative heat absorbed by the thermal emitter through the angle controller is incident at a low zenith angle. As for radiative heat emitted from the thermal emitter, it can be seen that when the cone-shaped reflective mirror is used, there is a large number of lines indicating that radiative heat emitted from the thermal emitter is reflected by the reflected mirror and returned back to the thermal emitter. Therefore, the emission efficiency is expected to decrease remarkably. However, it can be seen that the parabolic mirror angle controller can allow almost all of emitted radiative heat to proceed toward the outside regardless of an emission angle.

Further, the zenith angle of radiative heat absorbed by the thermal emitter depending on the r/H ratio and the percentage thereof can be seen. Specifically, when the number (frequency) of radiative rays absorbed by the thermal emitter at a constant r/H value is calculated, the percentage of radiative heat incident at a low zenith angle in a zenith angle region can be obtained. FIG. 5C shows the distribution of radiative rays obtained by sorting the number of radiative rays absorbed by the thermal emitter depending on the zenith angle at a constant r/H value in the simulation performed as shown in FIG. 5A and FIG. 5B. It can be seen that if the r/H value is 0.1115, when the cone-shaped reflective mirror is used, the frequency of radiative rays is uniformly distributed regardless of a zenith angle, which confirms that the percentage of radiative heat incident at a low zenith angle and absorbed by the thermal emitter through the reflective mirror is not much different from the percentage of radiative heat incident at a high zenith angle and absorbed by the thermal emitter through the reflective mirror. However, when the parabolic mirror angle controller is used, the percentage of radiative rays is very high at a low zenith angle, which confirms that the percentage of radiative heat incident at a low zenith angle and absorbed by the thermal emitter through the angle controller is very high.

The results are different because a uniform focus is not formed across the cone-shaped reflective mirror, which indicates that the formation of a focus across the angle controller is important. Accordingly, it can be seen that the radiative cooling device of the present disclosure including the angle controller having a focus allows radiative heat incident at a low zenith angle to be absorbed by the thermal emitter selectively and simultaneously allows radiative heat emitted from the thermal emitter to be emitted to the outside regardless of an emission angle. Therefore, it can be seen that the radiative cooling device of the present disclosure can achieve a higher cooling rate and a lower cooling temperature than a conventional radiative cooling device.

A second aspect of the present disclosure provides a method of cooling an object using the radiative cooling device according to the first aspect.

Descriptions of the parts common to the first aspect and the second aspect may be applied to both the first aspect and the second aspect, even though they are omitted hereinafter.

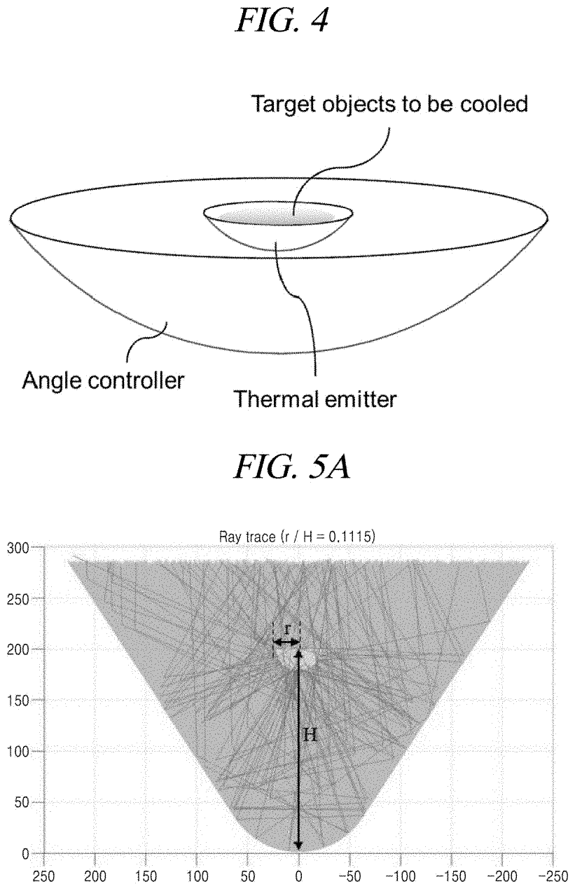

In an embodiment of the present disclosure, the object is brought into contact with the thermal emitter and the object may be cooled by radiative heat emitted from the thermal emitter. Specifically, the radiative cooling device can perform semipermanent cooling performance without using energy when the object is brought into contact with the thermal emitter. In particular, the radiative cooling device can implement a radiative cooling system in an easy and inexpensive way by adding subsidiary materials, such as a simple plate type structure, aluminum foil and styrofoam, to a mid-infrared thermal emitter as shown in FIG. 4. Therefore, it can be used as a no-power freezer or a no-power air conditioning system in developing countries.

The above description of the present disclosure is provided for the purpose of illustration, and it would be understood by those skilled in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. A radiative cooling device, comprising:
an angle controller; and
a thermal emitter,
wherein the angle controller allows radiative heat incident from the outside to be absorbed by the thermal emitter selectively depending on an incidence angle and allows radiative heat emitted from the thermal emitter to be emitted regardless of an emission angle.

2. The radiative cooling device of claim 1,
wherein the angle controller allows incident radiative heat to be at least one of transmitted, reflected and absorbed selectively depending on an incidence angle and allows radiative heat emitted from the thermal emitter to be transmitted or reflected to the outside regardless of an emission angle.

3. The radiative cooling device of claim 1,
wherein the angle controller allows radiative heat incident at a low zenith angle to be transmitted or reflected to the thermal emitter and allows radiative heat incident at a high zenith angle to be absorbed or to be reflected or transmitted to a direction in which the thermal emitter is not located.

4. The radiative cooling device of claim 1,
wherein the angle controller allows radiative heat emitted from the thermal emitter to be transmitted or reflected at a low zenith angle.

5. The radiative cooling device of claim 1,
wherein the angle controller functions to allow radiative heat incident from a low zenith angle region to converge on specific area, points, or focus, and the thermal emitter is located at the specific area, points, or focus.

6. The radiative cooling device of claim 1,
wherein the angle controller allows 50% or more, 75% or more, or 90% or more of radiative heat incident to the radiative cooling device at a zenith angle of from 0° to 90° to be absorbed by the thermal emitter at an angle of 20° or less, 35° or less, or 45° or less, respectively.

7. The radiative cooling device of claim 1,
wherein if a solid angle region for radiative heat released from the thermal emitter before reflection or transmission to the angle controller is A and a solid angle region for the radiative heat released from the thermal emitter after the reflection or transmission is B, the angle controller reduces a solid angle region for radiative heat released to the outside at a solid angle ratio of B/A<1.

8. The radiative cooling device of claim 1,
wherein the angle controller is located between the zenith and the thermal emitter, between the thermal emitter the ground surface or at both locations.

9. The radiative cooling device of claim 1,
wherein the angle controller includes at least one selected from a convex lens, a concave lens, a Fresnel lens, a metasurface, a metamirror and a metalens.

10. The radiative cooling device of claim 9,
wherein the thermal emitter is located at the focus of the angle controller.

11. The radiative cooling device of claim 1,
wherein the thermal emitter includes a multilayered thin film, a polymer layer including a regular pattern structure, a polymer layer including dispersed nanoparticles, a metamaterial or a metasurface.

12. A method of cooling an object using a radiative cooling device of claim 1.

13. The method of cooling an object of claim 12,
wherein the object is brought into contact with the thermal emitter and the object is cooled by radiative heat emitted from the thermal emitter.
